(19) United States
(12) Patent Application Publication
(10) Pub. No.: US 2025/0384880 A1
(43) Pub. Date: Dec. 18, 2025

(54) SMART DISPATCHER IN A COMPOSITE ARTIFICIAL INTELLIGENCE (AI) SYSTEM

(71) Applicant: Intuit, Inc., Mountain View, CA (US)

(72) Inventors: Daniel Leontin MOISE, Edmonton (CA); Horace CHAN, Edmonton (CA); Venkat Narayan VEDAM, Mountain View, CA (US); Rachit SENGUPTA, San Diego, CA (US)

(21) Appl. No.: 18/744,434

(22) Filed: Jun. 14, 2024

(51) Int. Cl. G10L 15/22; G06F 40/30; G10L 15/26

(52) U.S. Cl. CPC G10L 15/22; G06F 40/30; G10L 15/26

(57) ABSTRACT

Certain aspects of the disclosure provide methods and systems for implementing a composite artificial intelligence system. The method may include generating a user request from a user utterance submitted by a user. The method may also include classifying a user intent from the user request and a context of the user utterance. The method may furthermore include determining to send the user request to one of a first AI model or a second AI model based on a determination that the user intent is fullfillable by one of the first AI model or the second AI model. The method may in addition include generating a first response by one of the first AI model or the second AI model based on the determination. Method may moreover include transmitting the first response to the user.

### BACKGROUND

### Field

Aspects of the present disclosure relate to composite artificial intelligence systems. More particularly, aspects of the present disclosure relate to a smart dispatcher for use in a composite artificial intelligence system.

### Description of Related Art

Automated customer service (e.g., help desk) systems have existed for years as an efficient method of responding to common questions and issues encountered by users of goods and services. Especially as more products are becoming web-based, these products may include links or chat modules that directly connect to an automated help desk ready to instantly address a user's issues.

Common help desk systems employ natural language understanding to convert the utterances of a user into semantically similar terms that are pre-stored in the help desk system. Thus, the natural language understanding may respond correctly to a user regardless of how a question is phrased. However, natural language understanding requires that responses are pre-stored (e.g., human-curated) prior to being placed in operation. As a consequence, the natural language understanding is only able to answer questions directed to limited range of topics. In order for the natural language understanding to respond to a broader array of questions, a human needs to curate responses for each of the questions. This can be resource intensive, and thus, not feasible in terms of effort and storage requirements. Therefore, the natural language understanding system is capable of handling the commonly encountered issues, while the more complicated or less common issues may be passed to a human operator for disposition. Since answers are based on human-curated responses, the answers can be relied on as accurate, even for sensitive issues, such as medical and legal issues. In fact, medical and legal responses may be vetted by licensed professionals prior to being submitted to the help desk system.

In an effort to provide an automated help desk system that can handle a wide range of questions, including questions not previously encountered by support staff, generative artificial intelligence, such as large language models, are being used in place of natural language understanding models. The generative artificial intelligence models process natural language and based on the prompts and training, generate essentially unique answers in response to a user's question. Because generative artificial intelligence models are not limited to only human-curated responses, the generative artificial intelligence models can provide responses to a larger variety of questions beyond what is possible with natural language understanding models. However, generative artificial intelligence models are probabilistic systems that use probability to determine non-deterministic outputs. While this approach works quite well in many circumstances, there are frequent incidents of incorrect or entirely fictitious answers being provided (e.g., so-called hallucinations). In situations where there is high sensitivity to the correctness of answers, such as in medical or legal fields, answers provided by generative artificial intelligence models may not be sufficiently reliable to be deployed as part of a customer-facing system.

### SUMMARY

Certain aspects of the present disclosure provide a method for implementing a composite artificial intelligence (AI) system. The method may include generating a user request from a user utterance submitted by a user. The method may also include classifying a user intent from the user request and a context of the user utterance. The method may furthermore include determining to send the user request to one of a first AI model or a second AI model based on a determination that the user intent is fullfillable by one of the first AI model or the second AI model. The method may in addition include generating a first response by one of the first AI model or the second AI model based on the determination. The method may moreover include transmitting the first response to the user.

Certain aspects of the present disclosure provide a combined artificial intelligence system. The combined artificial intelligence system may include a deterministic AI model configured to generate a first response to a user intent using a set of human-curated responses. The combined artificial intelligence system may also include a generative AI model configured to generate the first response to the user intent. The combined artificial intelligence system may furthermore include a dispatcher configured to selectively direct a user utterance to one of the deterministic AI model or the generative AI model based on a determination that the user intent is fulfillable by the deterministic AI model. The dispatcher may include: a classifier configured to identify the user intent based on the user utterance and context extracted from an user request, a conversation tracker configured to maintain a conversation list, the conversation tracker adding the user intent and follow-up intents to the conversation list, the follow-up intents representing probable responses to subsequent user utterances provided by an user in reaction to the first response, and a responder configured to receive the first response from the selected one of the deterministic AI model or the generative AI model and present the first response to the user.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts a block representation of a composite artificial intelligence system in accordance with aspects of the present disclosure.

FIG. 2 depicts a process flow in accordance with aspects of the present disclosure.

FIG. 3A depicts a block representation showing constituent components of a composite artificial intelligence system in a first operational state in accordance with aspects of the present disclosure.

FIG. 3B depicts a block representation showing constituent components of a composite artificial intelligence system in a second operational state in accordance with aspects of the present disclosure.

FIG. 4 depicts a block representation showing constituent components of a smart dispatcher in accordance with aspects of the present disclosure.

FIG. 5 depicts a method for implementing a composite artificial intelligence system in accordance with aspects of the present disclosure.

FIG. 6 depicts a block representation of a processing system configured to implement aspects of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for implementing a composite AI system, such as for help desk or customer assistance services. Conventional AI-based customer assistance services often rely on a single AI model. For example, a natural language understanding (NLU) model may be used to process a customer's natural language utterances, e.g., requests, and classify the utterance in a topic group based on semantic similarities. Subsequently, one or more saved responses associated with the topic group may be sent to the customer in reply. The saved responses may include excerpts from a user manual, links to relevant websites, follow-up questions, and the like. NLU model-based systems generally provide highly accurate information quickly. However, since the responses need to be pre-stored in a human-curated response database in order for a reply to be available, a NLU model-based system is limited to responses that have been previously stored. Consequently, customer questions that fall outside of anticipated questions may not be answerable by the NLU system. NLU-based systems provide several benefits as well, such as, low latency and cost, accurate, vetted responses, short training period, and a focus on relevant topics.

Alternatively, generative AI (GenAI) models, such as large language models (LLM), for example, may be used to provide automated customer assistance services. The LLM receives a customer's utterance and generates a response in reply. The response may be uniquely generated based on the utterance and information accessible to the LLM. GenAI models allow for a much wider range of responses. However, GenAI systems may be resource intensive and slow to respond to a customer utterance. Moreover, in certain situations, GenAI systems have been known to suffer from hallucinations, in which erroneous or fictitious information is provided as an otherwise convincing response. Moreover, GenAI systems require more time to train, thus the training data may be older and even out of date by the time the GenAI system is operational. Also, GenAI models are generally trained over a wide range of data, and thus the GenAI system may lack domain-specific focus.

Aspects of the present disclosure leverages the strengths of both NLU models and GenAI models to respond to customer utterances, while also reducing or avoiding the deficiencies of each type of AI model. In accordance with aspects of the present disclosure, and disclosed in greater detail below, a smart dispatcher unit uses a classifier, such as a pre-trained NLU model, to process user utterances in order to extract a user intent. Based on the user intent, the smart dispatcher matches the user intent to intents stored in a master intent list. The master intent list reflects intents that associated with human-curated responses, and thus, intents that can be answered by the NLU model. User intents that are do not match any intents stored in a master intent list may be handled by the GenAI model.

Aspects of the present disclosure maintain an ongoing conversation within either the NLU operating mode or the GenAI operating mode for follow-up responses, as this provides a more natural conversation. Therefore the smart dispatcher maintains a conversation list that includes a list of follow-up intents that reflect probably subsequent related intents that may arise during the conversation with the user. The conversation list is maintained and updated throughout the conversation while responses are provided by the NLU operating mode. Moreover the NLU operating mode applies rules and templates to the human-curated responses to personalize responses based on user information.

The smart dispatcher receives the response from the NLU model or the GenAI model and renders the response in a format appropriate for transmission to the user.

Aspects of the present disclosure also allow conversations to shift between the NLU operating mode and the GenAI operating mode as necessary. For example, initial responses may be provided by the GenAI model, while critical responses may be provided by the NLU model. Critical responses include statements and advice that require vetting by a licensed professional. For example, legal advice can only be provided by a licensed attorney. Therefore, any response that may have legal implications should be vetted by an attorney and may therefore require a human-curated response. Similarly, a licensed physician or financial advisor is required to provide medical advice and financial advice, respectively. While a response generated by the GenAI model may be correct, such a response cannot be relied upon, thus such responses need to be provided by the NLU model.

Throughout the present disclosure the terms “user” and “customer” are used interchangeably to refer to an individual providing user utterances to the composite AI system to obtain a resolution to a particular issue, which may include troubleshooting a product or service, resolving a billing issue, scheduling or changing an appointment, initiating a purchase, or any other request that may be typically be made to a customer service agent. Additionally, the term “product” in the context of the present disclosure is understood to encompass both articles of manufacture (e.g., goods) and services.

While aspects are described herein with respect to a customer service system as one practical application, aspects of the present disclosure are not limited to only customer support systems. Rather aspects of the present disclosure may be implemented in any system that captures end user inputs in a natural language, where different AI models can be applied individually, each with its own strengths and weaknesses. By compositing different types of AI models through a smart dispatching system, aspects of the present disclosure leverage the strengths (e.g., low response latency, expansive and creative responses, response accuracy, etc.) of different AI model types, while reducing or eliminating the weaknesses (e.g., high response latency, hallucinations, limited responses, etc.).

### Example Composite AI System

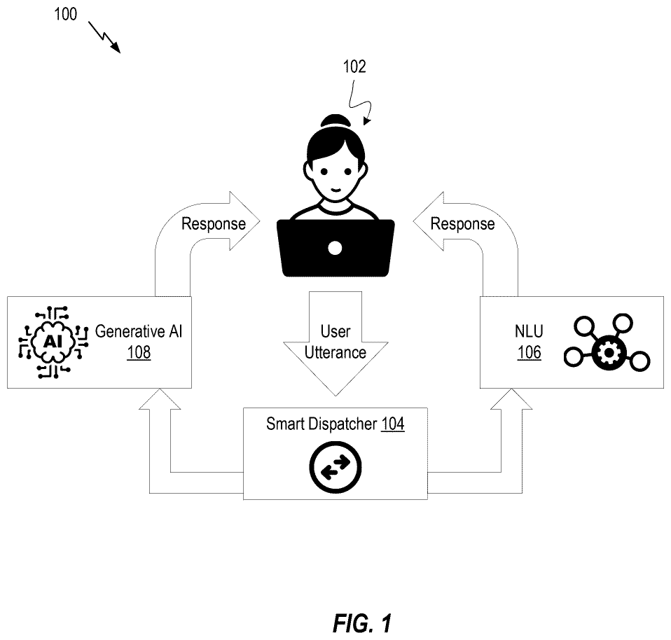

FIG. 1 depicts a generalized block representation of a composite AI system 100. The composite AI system may be a system configured as, for example, an automated help desk in which a user, e.g., customer 102, provides a user utterance. The user utterance may be in the form of an audio or written content. The user utterance is submitted to a smart dispatcher 104. The smart dispatcher 104, as will be described in greater detail below, analyzes the user utterance to determine an intent of the customer 102. An intent, for example, may be a request for assistance with a product or service, a billing issue, or the like. Based on the analysis performed by the smart dispatcher 104, and in accordance with preset rules, the user utterance and/or intent is presented to either a deterministic AI module, such as an NLU model 106, or probabilistic AI model, such as a GenAI module 108, where a response is obtained and presented to the customer 102. The response presented to the customer 102 may be a final resolution to the customer's 102 inquiry. Alternatively, the response presented may request additional information from the customer 102. Additional user utterances are processed as above until a final resolution is presented to the customer 102.

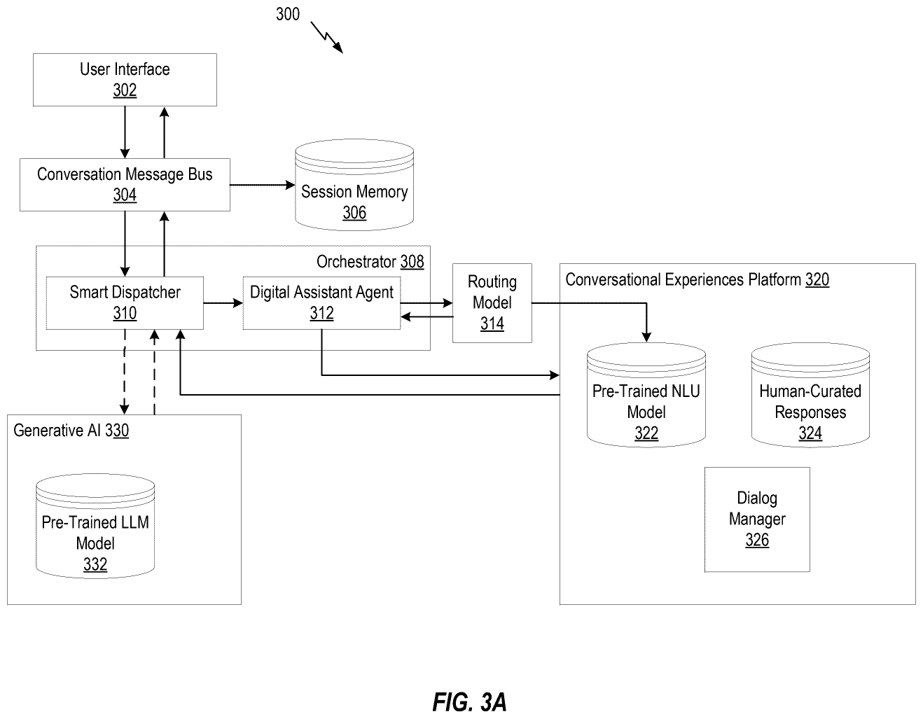

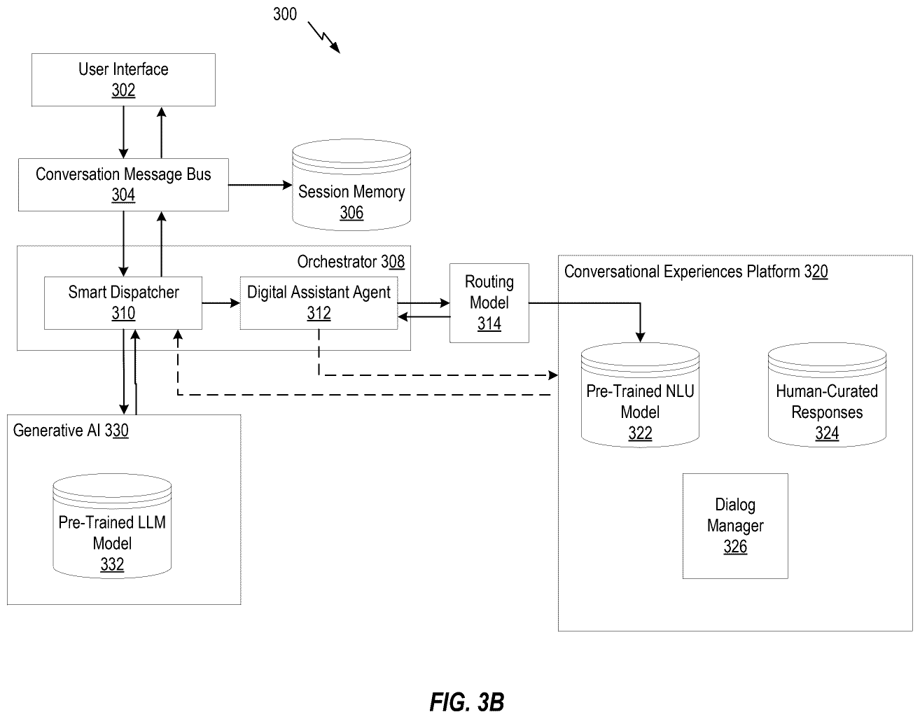

The NLU model 106 includes a database of human-curated responses (e.g., 324 shown in FIG. 3A) from which the NLU model 106 provides answers to the customer 102. Since the human-curated responses used by the NLU model 106 are generated by humans, these responses may be vetted for accuracy. Thus, the NLU model 106 may be used to respond to questions that require a high level of accuracy and confidence. For example, in cases where aspects of the present disclosure are employed in a financial setting, questions regarding tax deductions or accounting practice may be vetted by appropriately licensed tax or finance professionals. In another example, aspects of the present disclosure may be employed in a medical setting, such as a diagnostic aid, questions regarding a possible medical diagnosis may be vetted by appropriately licensed physicians.

The GenAI module 108, may include a GenAI model, such as a pre-trained LLM model, that is trained on a set of relevant datasets. For example, the LLM may be trained using manuals and documents relating to the functions of a product or service. In cases where the product is a financial product, such as tax preparation software, and the like, the LLM model may be trained on tax and other finance related data. However, GenAI is known to occasionally generate incorrect or incomplete answers. Moreover, the responses generated by a GenAI model are unique, thus there is no feasible method to verify responses for accuracy by an appropriately licensed professional before providing the response to the customer 102. Consequently, while the GenAI module 108 may be relied upon to provide answers to questions related to product functionality or general non-critical problems, the GenAI module 108 may not be appropriate for providing answers to critical questions involving interpretation of laws or medical diagnosis and treatments, for example.

### Example Composite AI System Process Flow

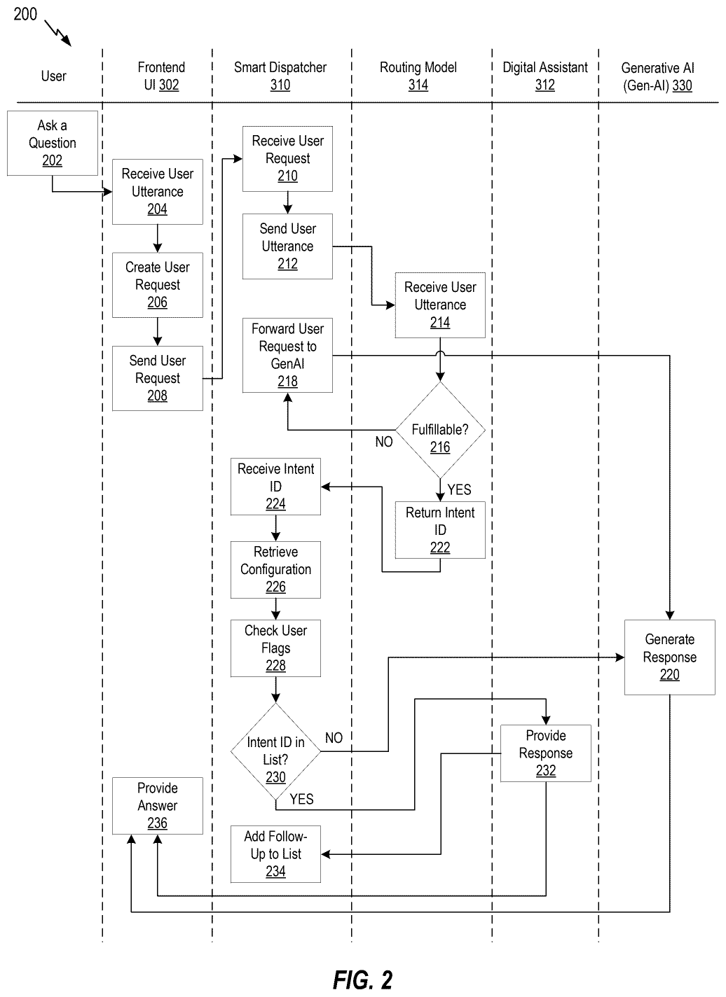

Aspects of the present disclosure are described herein with reference to a process flow 200 shown in FIG. 2, and block representations of a first operational state of a composite AI system 300 of FIG. 3A and a second operational state of the composite AI system 300 of FIG. 3B. FIG. 3A and FIG. 3B show the same composite AI system 300. However, FIG. 3A shows the operational state of the composite AI system 300 in which a response to a user utterance is provided by a conversational experiences platform 320 using a pre-trained NLU model 322. The conversational experiences platform 320 may employ an NLU model, or any other appropriate deterministic AI model. In contrast, FIG. 3B shows the operational state of the composite AI system 300 in which a response to a user utterance is generated by a GenAI module 330 using, for example, an LLM model, or any other appropriate probabilistic AI model. In FIG. 3A and FIG. 3B the active communication paths are represented by solid arrows, while inactive paths are represented by dashed lines.

As shown in the process flow 200 in FIG. 2, a user, (e.g., customer 102 shown in FIG. 1) asks a question at 202 using, for example, a front end user interface (UI) 302 shown in FIG. 3A. In one implementation, the UI 302 receives the user utterance, at 204, as a text message typed by the customer into a text field of a chat module provided on a website, or in a product, for example. In another implementation, the UI 302 receives, at 204, the user utterance in an audio form spoken by the customer over a telephone, for example. A speech-to-text component may be used by the composite AI system 300 to transcribe spoken user utterances into text to facilitate further processing by the composite AI system 300.

At 206, the UI 302 creates a user request, the user request includes the user utterance, and may also include customer information (e.g., user information), such as the customer's name, customer location, customer role, current position within the product, and the like. Experience information (e.g., from which product is the customer utterance originating) may also be included in the user request. Additionally, certain aspects of the present disclosure may include application related context information for the user. The user request may be formatted as a structured text elements, such as JSON, XML, or in other appropriate text-based format. The customer information and experience information form the basis of the context that the composite AI system 300 uses along with the user utterance to provide a response that is personalized to the individual customer.

At 208, the user request is sent by the UI 302 to an orchestrator module 308, shown in FIG. 3, by way of a conversation message bus 304. The orchestrator module 308 includes a smart dispatcher 310 and a digital assistant 312. In addition to transmitting the user request from the UI 302 to the orchestrator module 308, the conversation message bus 304 also transmits a copy of the user utterance to session memory 306. The session memory 306 stores the entirety of the present conversation with the customer, including user utterances, along with associated context, and responses.

At 210, the user request is received by the smart dispatcher 310. The smart dispatcher 310 includes a classifier model that identifies the intent of the customer (e.g., user intent) by processing the user utterance and context provided in the user request. The intent may be, for example, assistance troubleshooting a product, correcting a billing issue, guidance using a particular product feature, and the like. The classifier may employ natural language processing (NLP) or other appropriate machine learning models to classify the text of the user utterance and identify the user intent. For example, in certain implementation the classifier may be chosen based on the number of intents and data training available. Thus, if the number of intents is relatively small (hundreds of intents) and the number of data training is also small, an intent matching model using rules-based grammar matching may be leveraged. For larger numbers of intents and training data, machine learning (ML) transformer models may be leveraged.

At 212 the user intent is sent by the smart dispatcher 310, and received at 214 by a routing model 314. The routing model 314, in combination with the pre-trained NLU model 322, determines if the user intent is answerable (fulfillable), at 216, by the conversational experiences platform 320. In one example, whether the user intent is fulfillable by the conversational experiences platform 320 is determined by identifying an intent previously stored in the conversational experiences platform 320 that matches the user intent of the user utterance determined by the classifier model. Semantically similar user utterances may be matched to a same stored intent. In accordance with certain aspects, the user utterance is provided to the NLU model 322. The NLU model 322 classifies the user utterance to identify a user intent. A fulfillable user intent is an intent that has a matching intent in a list of previously stored intents (e.g., master intent list). The previously stored intents may be arranged in a lookup table, database, or similar data structures. Each of the previously stored intents may be associated with a unique intent ID.

At 216, if the user intent is determined to not be fulfillable by the conversational experiences platform 320, the routing model signals the smart dispatcher to forward the user utterance to the GenAI module 330. The smart dispatcher 310, upon receiving the signal from the routing model 314, at 218 forwards the user request to the GenAI module 330, as shown in FIG. 3B. At 220, the GenAI module 330, processes the user request and generates a response. The generated response is transmitted to the UI 302 and provided as an answer to the customer at 236.

However, if the user intent is determined to be fulfillable by the conversational experiences platform 320, the routing model 222, returns a user intent ID, at 222, to the smart dispatcher 310. The smart dispatcher receives the user intent ID at 224 and proceeds to retrieve a configuration corresponding to an experience ID at 226. The experience ID may be a product identifier, such as a product name or reference number. Thus, the experience information provided in the user request determines the experience ID used to retrieve the corresponding configuration. According to aspects of the present disclosure, multiple configurations may be provided, where each configuration is directed to an individual topic or domain. For example, separate configurations may be provided for user requests related to tax questions, bookkeeping questions, or individual products. Each configuration may be a lookup table or database of related intent IDs corresponding to the domain of the configuration. Each of the intent IDs in the configuration includes one or more human-curated responses from the database of human-curated responses 324. Additionally the configuration may also include flags that define whether the configuration is one that should be handled only by the conversational experiences platform 320, the GenAI module 330, or both. Other flags may be provided in the configuration as well that may limit the applicability of the configuration to certain geographic regions (e.g., locales), such as United States, California, New York State, Canada, Mexico, etc., where the responses associated with the configuration may be related to tax regulations, for example. Additionally, some flags may be provided for system testing and development purposes, such that conversations by certain participating users may be routed to either the GenAI module 330 or the NLU model 322, for example. In certain implementation of the aspects of the present disclosure, flags may be provided to identify a user platform, for example, mobile device, desktop computer, or even particular operating systems. This information may be particularly useful to the system for formatting responses to be easily viewed on the target platform. For example, a desktop computer, or laptop, may allow for detailed responses, while users of a mobile device, with its limited screen size, may prefer more succinct responses. Additionally, platform flags may be useful in addressing utterances related to technical support, where certain issues may be resolved differently depending on the operating system involved.

At 228, the smart dispatcher 310 checks user flags that correspond to flags set in the configuration. The user flags may be derived from the customer information and experience information provided in the user request. For example, the UI 302 may include interactive elements (e.g., dropdown menus, text input fields, etc.) for the customer to submit requested information such as address. The user flags determine whether the configuration may be used to address the user utterance. For example, one user flag may indicate that the user is located in Canada, thus a configuration that is limited to only addressing utterances in the United States cannot be used. Instead, the smart dispatcher may select a configuration that includes a location flag for Canada. Thus, at 226 the smart dispatcher 310 may retrieve several configurations associated with the domain of the user intent ID received at 224, but once the user flags are checked at 228, one or a small number of configurations may remain, or even no configurations may remain.

At 230, any remaining configurations are scanned to determine if user intent ID matches any intent IDs in the configuration. If the user intent ID is not matched in any of the remaining the configurations, then the smart dispatcher 310 transmits the user request to the GenAI module 330, as shown in FIG. 3B. As noted above, at 220, the GenAI module 330, processes the user request and generates a response. The generated response is then transmitted to the UI 302 and provided as response to the customer at 236.

However, if at least one configuration has an intent ID matching the user intent ID at 230, then the smart dispatcher 310 transmits the user request to a digital assistant 312.

At 232, the digital assistant retrieves a human-curated response associated with the configuration and user intent ID from the database of human-curated responses 324 and transmits the response to the UI 302 and provided as an answer to the customer at 236.

In accordance with certain aspects of the present disclosure, a dialog manager 326 may apply response rules and response templates. Thus, the responses are generated based on a set of rules that are evaluate for a user context. For example, if locale is US and platform is MOBILE, the rules may invoke APIs to obtain data for the user and evaluate that data in the rule. In cases where a rule includes one or more templates (placeholders), the one or more templates are added to the response (e.g. “The tax refund for the user is ${tax_efile.amount}). The {tax_efile.amount} template may be replaced by the dialog manager 326 with an actual calculated value, for example, before the response is provided to the user.

The dialog manager 326 personalizes the response using the customer information. Additionally, the digital assistant 312 causes the smart dispatcher 310 to add follow-up intent IDs, corresponding to probable follow-up responses, to a user conversation list at 234. Follow-up responses are pre-defined human-curated responses associated with the follow-up intent IDs in the configuration. The user conversation list may be used to provide responses to additional utterances issued by the customer in response to the answer provided at 236. However, the GenAI module 330 does not use a user conversation list and instead generates each response in real time. The smart dispatcher 310 may refer to the user conversation list each time a new utterance is received from the customer. As long as the current utterance has the same user intent ID, the digital assistant 312 may use one of the follow-up responses as an answer. However, if the user issues an utterance that shifts the conversation to a new user intent—thus, causing the user intent ID to change—the smart dispatcher 310 processes the new user request, as previously described, by returning to 210 and proceeding accordingly. Each time the user intent ID changes the user conversation list is cleared and populated with new follow-up responses associated with the new user intent ID.

### Example Smart Dispatcher for Implementing a Composite AI System

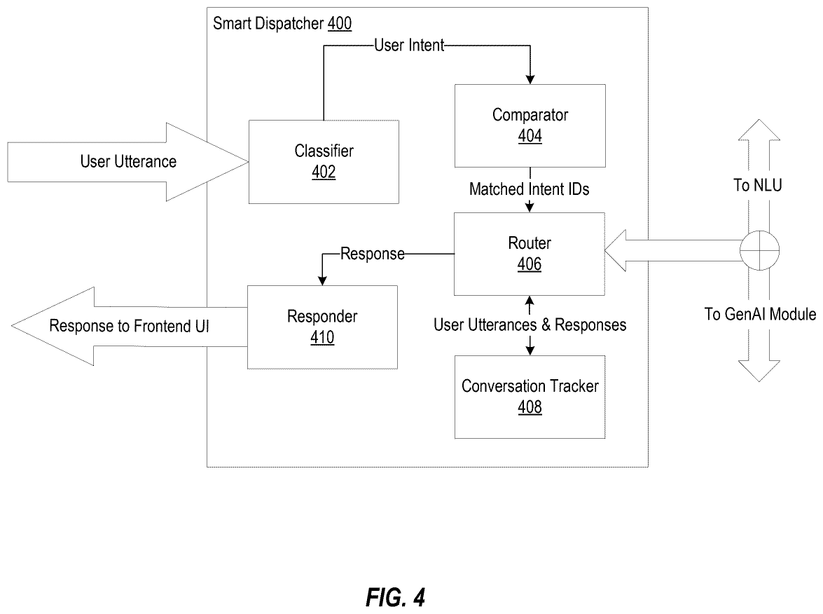

FIG. 4 depicts a block representation of components of a smart dispatcher 400 in accordance with aspects of the present disclosure. The smart dispatcher 400 shown in FIG. 4 is configured to implement the composite AI system described above with respect to FIGS. 2, 3A, and 3B. The smart dispatcher 400 includes a classifier 402, comparator 404, router 406, conversation tracker 408 and a responder 410.

The classifier 402 is configured to, for example, perform process step 210 in FIG. 2 and described above, such that the classifier 402 may identify a user intent based on a user utterance and context extracted from a user request. The context may be determined based on customer information and experience information included in the user request.

The comparator 404 is configured to, for example, perform aspects of process step 216 in FIG. 2, such that the comparator 404 may compare the user intent against a master intent list to identify a matching intent. The master intent list includes a list of pre-selected intents for which a set of human-curated responses are available through a deterministic AI model.

The router 406 is configured to, for example, perform aspects of process step 216 in FIG. 2, such that the router 406 may selectively direct a user utterance to one of the deterministic AI model or the generative AI model based on a determination of whether the user intent is fulfillable by the deterministic AI model. The deterministic AI model may be, for example, a natural language understanding model (e.g., NLU model 106 in FIG. 1). The generative AI model (e.g., GenAI module 108 in FIG. 1), may be implemented by large language model, or the like.

User utterances having user intents that match intents in the master intent list are directed to the deterministic AI model. User utterances that have user intents that do not match intents in the master intent list are directed to the generative AI model.

The conversation tracker 408 is configured to, for example, perform aspects of process step 234 in FIG. 2, such that the conversation tracker 408 may maintain a conversation list. For example the conversation tracker 408 may add the user intent and follow-up intents to the conversation list. The follow-up intents represent probable responses to subsequent user utterances provided by a user in reaction to the first response. The conversation tracker 408 is further configured to update the conversation list based on subsequent user utterances received in reaction to the first response. The conversation tracker 408 function in combination with the deterministic AI model to provide a natural conversation flow with the user.

The responder 410 is configured to, for example, perform aspects of process step 236 in FIG. 2, such that the responder 410 may receive the first response from the selected one of the deterministic AI model or the generative AI model and present the first response to the user via a user interface (e.g., UI 302 in FIG. 3A).

### Example Method for Implementing a Composite AI System

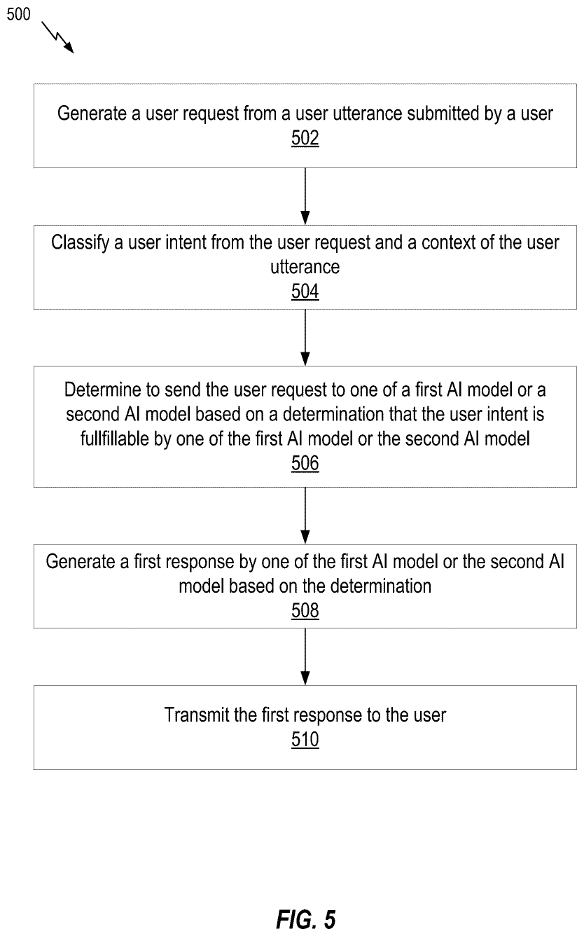

FIG. 5 depicts an example method 500 implementing a composite artificial intelligence (AI) system, (e.g., 100 shown in FIG. 1) in accordance with aspects of the present disclosure.

As described above, NLU-based response systems can only provide responses that have been previously generated by a human agent (e.g., technician, medical professional, financial advisor, legal advisor, or the like). While the human-curated response may be personalized based on rules and templates, an NLU-based system cannot provide original responses. However, the NLU-based response system benefits from having each response vetted for accuracy. Thus, responses received from the NLU-based response system may be relied upon for critical questions. On the other hand, GenAI systems are capable of responding to a wide range of utterances with responses generated based on the utterance and a domain-specific knowledgebase. However, responses generated by a GenAI system may be unreliable, as such systems have been known to generate fictitious responses. Thus, GenAI systems are inappropriate for providing responses to critical questions.

The method 500, described herein, implements aspects of the present disclosure to overcome the lack of range in NLU response systems and lack of reliability of GenAI response systems. By using a smart dispatcher to determine the intent, or purpose, of a user utterance, the method 500 routes the user utterance to a GenAI module for non-critical intents, and to an NLU with human-curated responses for critical intents. The method 500 may be able to respond to a much wider range of utterances than an NLU-based system while still maintaining confidence in response accuracy and reliability than is possible with a GenAI system. Moreover, since the method 500 leverages the strengths of both the NLU and GenAI models, the method 500 is able to overcome the deficiencies in each model in an efficient and economical manner.

At 502, the method 500 generates a user request from a user utterance submitted by a user (e.g., 102 shown in FIG. 1). Additionally the user request may include customer information, and experience information. As described above, the customer information may include information such as customer name, customer location, customer role, current position within the product, and the like. Experience information may include information such as from which product the customer utterance originating. The user request may be formatted as JSON, XML, or other appropriate text-based format. The customer information, and experience information provide context for the user utterance.

At 504, the method 500 classifies a user intent from the user utterance and a context of the user utterance. The context is determined from the customer information and the experience information. Context may be used by the method 500 to personalize the response to the individual user.

At 506, the method 500 determines to send the user request to one of a first AI model or a second AI model based on a determination that the user intent is fullfillable by one of the first AI model or the second AI model. At 506, the method may, in accordance with certain aspects of the present disclosure, compare the user intent against a master intent list (e.g., list of previously stored intents). The master intent list may include a list of intents for which a set of human-curated responses are available through the first AI model.

According to certain aspects of the present disclosure, the first AI model may be a deterministic AI model, such as an NLU model (e.g., 106 shown in FIG. 1) using human-curated responses, and the second AI model may be a generative AI model (e.g., 108 shown in FIG. 1), such as an LLM, referencing a predefined set of information.

At 508, the method 500 generates a first response by one of the first AI model or the second AI model based on the determination. In accordance with certain aspects of the present disclosure, in cases where the first response is generated using the NLU model, the method 500 assign an intent identifier associated with at least one selected response from among the set of human-curated responses stored in a database of human-curated responses (e.g., 324 shown in FIG. 3A). The selected response may correspond to the user intent. The user intent may be added to a conversation list. Follow-up intents may also be added to the conversation list. The follow-up intents represent probable responses to utterances provided by a user in reaction to the first response. The follow-up intents may represent probable responses to utterances provided by a user in reaction to the first response. In cases where the first response is generated using the NLU model, the method 500 may apply response rules and response templates, by a dialog manager (e.g., 326 shown in FIG. 3A), to the set of human-curated responses. The dialog manager may personalize the first response using the customer information.

At 510, the method transmits the first response to the user via a UI (e.g., 302 shown in FIG. 3A).

Note that FIG. 5 is just one example of a method consistent with aspects described herein, and other methods having additional, alternative, or fewer steps are possible consistent with this disclosure.

### Example Processing System for Implementing a Composite AI System

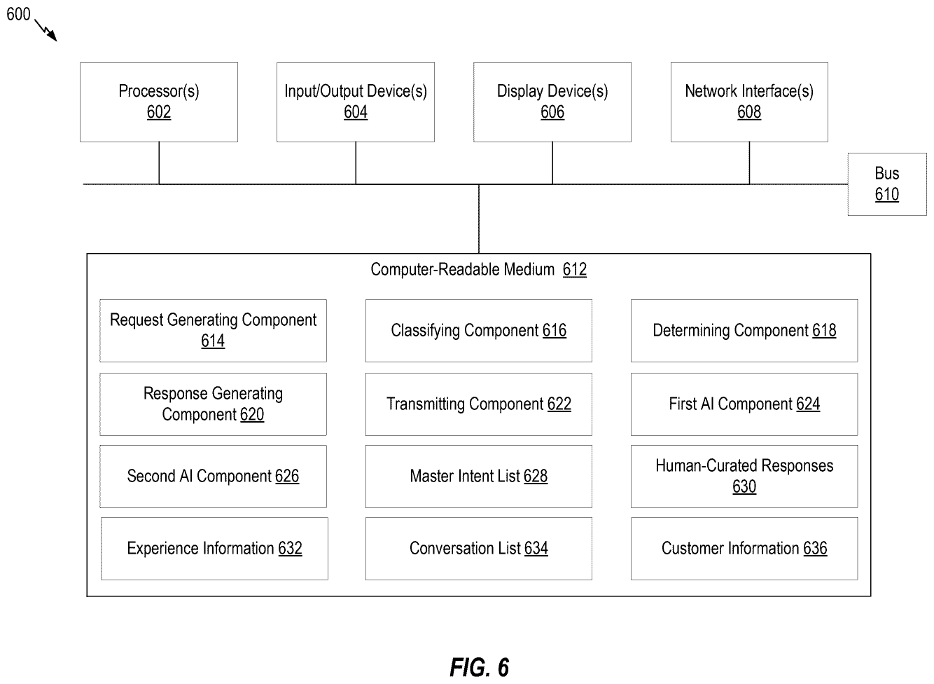

FIG. 6 depicts an example processing system 600 configured to perform various aspects described herein, including, for example, the process flow 200 as described above with respect to FIG. 2, and the method 500 as described above with respect to FIG. 5.

Processing system 600 depicts an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 600 includes one or more processors 602, one or more input/output devices 604, one or more display devices 606, and one or more network interfaces 608 through which processing system 600 is connected to one or more networks (e.g., a local network, an intranet, the Internet, or any other group of processing systems communicatively connected to each other), and computer-readable medium 612.

In the depicted example, the aforementioned components are coupled by a bus 610, which may generally be configured for data and/or power exchange amongst the components. Bus 610 may be representative of multiple buses, while only one is depicted for simplicity.

Processor(s) 602 are generally configured to retrieve and execute instructions stored in one or more memories, including local memories like the computer-readable medium 612, as well as remote memories and data stores. Similarly, processor(s) 602 are configured to retrieve and store application data residing in local memories like the computer-readable medium 612, as well as remote memories and data stores. More generally, bus 610 is configured to transmit programming instructions and application data among the processor(s) 602, display device(s) 606, network interface(s) 608, and computer-readable medium 612. In certain embodiments, processor(s) 602 are included to be representative of a one or more central processing units (CPUs), graphics processing unit (GPUs), tensor processing unit (TPUs), accelerators, and other processing devices.

Input/output device(s) 604 may include any device, mechanism, system, interactive display, and/or various other hardware components for communicating information between processing system 600 and a user of processing system 600. For example, input/output device(s) 604 may include input hardware, such as a keyboard, touch screen, button, microphone, and/or other device for receiving inputs from the user. Input/output device(s) 604 may further include display hardware, such as, for example, a monitor, a video card, and/or other another device for sending and/or presenting visual data to the user. In certain embodiments, input/output device(s) 604 is or includes a graphical user interface.

Display device(s) 606 may generally include any sort of device configured to display data, information, graphics, user interface elements, and the like to a user. For example, display device(s) 606 may include internal and external displays such as an internal display of a tablet computer or an external display for a server computer or a projector. Display device(s) 606 may further include displays for devices, such as augmented, virtual, and/or extended reality devices.

Network interface(s) 608 provide processing system 600 with access to external networks and thereby to external processing systems. Network interface(s) 608 can generally be any device capable of transmitting and/or receiving data via a wired or wireless network connection. Accordingly, network interface(s) 608 can include a communication transceiver for sending and/or receiving any wired and/or wireless communication. For example, Network interface(s) 608 may include an antenna, a modem, a LAN port, a Wi-Fi card, a WiMAX card, cellular communications hardware, near-field communication (NFC) hardware, satellite communication hardware, and/or any wired or wireless hardware for communicating with other networks and/or devices/systems. In certain embodiments, network interface(s) 608 includes hardware configured to operate in accordance with the Bluetooth® wireless communication protocol.

Computer-readable medium 612 may be a volatile memory, such as a random access memory (RAM), or a nonvolatile memory, such as nonvolatile random access memory, phase change random access memory, or the like. In this example, computer-readable medium 612 includes a request generating component 614, classifying component 616, determining component 618, response generating component 620, transmitting component 622, first AI component 624, second AI component 626, master intent list 628, human-curated responses 630, experience information 632, conversation list 634 and customer information 636.

In certain embodiments, the first AI component 624 (NLU model 106 in FIG. 1) is a deterministic AI model, such as a natural language understanding model. The first AI component 624 may have access to the human-curated responses 630 from which to use to respond to user utterances.

In certain embodiments, the second AI component 626 (GenAI module 108 in FIG. 1) is a generative AI model, such as a large language model. The second AI component 626 generates personalized responses to user utterances based on pre-training and fine tuning performed on the second AI component 626.

In certain embodiments, the request generating component 614, in combination with the processor 602, is configured to perform block 502 of method 500 shown in FIG. 5, for example, such that the request generating component 614 receive a user utterance from a user interface (e.g., UI 302 of FIG. 3A) by way of the network interface 608. The request generating component 614 may also retrieve customer information 636 and experience information 632, which may be provided through the user interface, or stored in a customer database, for example. The request generating component 614 combines the user utterance, the customer information 636 and experience information 632 into a user request.

In certain embodiments, the classifying component 616, in combination with the processor 602, is configured to perform block 504 shown in FIG. 5, for example, such that the classifying component 616 may classify a user intent from the user request and a context of the user utterance. The context is derived from the customer information 636 and experience information 632 included in the user request. The classifying component 616 may use a NLU model or other AI model capable of classifying natural language. For example the classifying component 616 may use the first AI component 624 (NLU model 106 in FIG. 1) to process the user utterance in order to ascertain the user's purpose, e.g., what the user wishes to accomplish by way of the user utterance. The user's purposes is classified by classifying component 616 as the user intent. Alternatively, the classifying component 616 may use a dedicated classifier separate from the first AI component 624. For example, in certain implementation the classifier may be chosen based on the number of intents and data training available. Thus, if the number of intents is relatively small (hundreds of intents) and the number of data training is also small, an intent matching model using rules-based grammar matching may be leveraged. For larger numbers of intents and training data, machine learning (ML) transformer models may be leveraged.

In certain embodiments, the determining component 618, in combination with the processor 602, is configured to perform block 506 shown in FIG. 5, for example, such that the determining component 618 determines whether to send the user request to one of either the first AI component 624 or the second AI component 626 (GenAI module 108 in FIG. 1) based on a determination that the user intent is fullfillable by one of the first AI component 624 or the second AI component 626. The determining component 618 may compare the user intent against the master intent list 628 (e.g., list of previously stored intents). The master intent list includes a list of intents for which a set of human-curated responses are available through the first AI component 624. Additionally, the determining component 618 may identify an intent in the master intent list that match the user intent. The determining component 618 may determine to send the user response to the first AI component 624 if the user intent matches at least one intent in the master intent list 628. The determining component 618 may determine to send the user response to the second AI component 626 in cases where the user intent does not match intents in the master intent list 628.

In certain embodiments, the response generating component 620, in combination with the processor 602, is configured to perform block 508 shown in FIG. 5, for example, such that the response generating component 620 generates a first response by one of the first AI component 624 or the second AI component 626 based on the determination made by the determining component 618.

The response generating component 620, in cases where the response is generated by the first AI component 624, may retrieve an initial response from the human-curated responses 630 stored, for example in a database (e.g., human-curated responses 324 in FIG. 3A) indexed by intent IDs. The database may also identify, for each human-curated response 630, one or more follow-up responses (which are also human-curated responses 630) that may apply to subsequent user utterances. The response generating component 620, in cases where the response is generated by the first AI component 624, may also create a conversation list populated with follow-up responses related to the initial human-curated response 630. The conversation list may be stored in memory, such as session memory 306 in FIG. 3A.

As long as user utterances continue to have the same intent ID, the response generating component 620 may use human-curated responses 630 in the conversation list. However, if, during the course of the conversation, a user utterance shifts the user intent such that a new intent ID is assigned to the user intent, the current conversation list is cleared and repopulated with follow-up responses related to the new intent ID.

In some cases, a conversation may initially have user utterances that are determined to be handled by the first AI component 624, but during the course of the conversation the user utterance may shift to intents determined by the determining component 618 to be handled by the second AI component 626. In such a case, the response generating component 620 may generate the current response with the second AI component 626. Conversations can progress in the opposite direction as well, such that response may initially be generated by the second AI component 626 and later shift to responses being generated by the first AI component 624.

Moreover, the second AI component 626 may be considered the default generator of response, with the first AI component 624 being used to respond to specific user intents that require the accuracy provided by human-curated response 630, such as when the response may involve legal, financial or medical advice. The human-curated responses 630 can be vetted by licensed professionals prior to being added to the human-curated response database, thus ensuring that the human-curated responses 630 meet appropriate legal requirements.

In certain embodiments, the transmitting component 622, in combination with the network interface 608, is configured to perform block 510 shown in FIG. 5, for example, such that the transmitting component 622 transmits the first response to the user via the user interface.

Note that FIG. 6 is just one example of a processing system consistent with aspects described herein, and other processing systems having additional, alternative, or fewer components are possible consistent with this disclosure.

### Example Clauses

Implementation examples are described in the following numbered clauses:

Clause 1: A method for implementing a composite artificial intelligence (AI) system, comprising: generating a user request from a user utterance submitted by a user; classifying a user intent from the user request and a context of the user utterance; determining to send the user request to one of a first AI model or a second AI model based on a determination that the user intent is fullfillable by one of the first AI model or the second AI model; generating a first response by one of the first AI model or the second AI model based on the determination; and transmitting the first response to the user.

Clause 2: The method of Clause 1, wherein determining to send the user request to one of the first AI model or the second AI model further comprises comparing the user intent against a master intent list, the master intent list including a list of intents for which a set of human-curated responses are available through the first AI model.

Clause 3: The method of Clause 1 or Clause 2, wherein the user request is generated based on at least the user utterance, customer information, and experience information, where the customer information, and experience information provide the context of the user utterance.

Clause 4: The method of any one of Clauses 1-3, further comprising generating the first response using a natural language understanding (NLU) model as the first AI model, generating the first response including: assigning an intent identifier associated with at least one selected response from among the set of human-curated responses, the selected response corresponding to the user intent; adding the user intent to a conversation list; and adding follow-up intents to the conversation list.

Clause 5: The method of any one of Clauses 1-4, wherein the follow-up intents represent probable responses to utterances provided by a user in reaction to the first response.

Clause 6: The method of any one of Clauses 1-5, wherein generating the first response using the NLU model further comprises: applying response rules and response templates, by a dialog manager, to the set of human-curated responses; and personalizing, by the dialog manager, the first response using the customer information.

Clause 7: The method of any one of Clauses 1-6, wherein the first AI model is a natural language understanding (NLU) model using human-curated responses, and the second AI model is a generative AI model referencing a predefined set of information.

Clause 8: A processing system, comprising: a memory comprising computer-executable instructions; and a processor configured to execute the computer-executable instructions and cause the processing system to perform a method in accordance with any one of Clauses 1-7.

Clause 9: A processing system, comprising means for performing a method in accordance with any one of Clauses 1-7.

Clause 10: A non-transitory computer-readable medium storing program code for causing a processing system to perform the steps of any one of Clauses 1-7.

Clause 11: A computer program product embodied on a computer-readable storage medium comprising code for performing a method in accordance with any one of Clauses 1-7.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for implementing a composite artificial intelligence (AI) system, comprising:
generating a user request from a user utterance submitted by a user;
classifying a user intent from the user request and a context of the user utterance;
determining to send the user request to one of a first AI model or a second AI model based on a determination that the user intent is fullfillable by one of the first AI model or the second AI model;
generating a first response by one of the first AI model or the second AI model based on the determination; and
transmitting the first response to the user.

2. The method of claim 1, wherein determining to send the user request to one of the first AI model or the second AI model further comprises comparing the user intent against a master intent list, the master intent list including a list of intents for which a set of human-curated responses are available through the first AI model.

3. The method of claim 2, wherein the user request is generated based on at least the user utterance, customer information, and experience information, where the customer information, and the experience information provide the context of the user utterance.

4. The method of claim 3, further comprising generating the first response using a natural language understanding (NLU) model as the first AI model, generating the first response including:
assigning an intent identifier associated with at least one selected response from among the set of human-curated responses, the selected response corresponding to the user intent;
adding the user intent to a conversation list; and
adding follow-up intents to the conversation list.

5. The method of claim 4, wherein the follow-up intents represent probable responses to utterances provided by a user in reaction to the first response.

6. The method of claim 4, wherein generating the first response using the NLU model further comprises:
applying response rules and response templates, by a dialog manager, to the set of human-curated responses; and
personalizing, by the dialog manager, the first response using the customer information.

7. The method of claim 1, wherein the first AI model is a natural language understanding (NLU) model using human-curated responses, and the second AI model is a generative AI model referencing a predefined set of information.

8. A processing system, comprising:
a memory comprising computer-executable instructions;
and a processor configured to execute the computer-executable instructions and cause the processing system to:
generate a user request from a user utterance submitted by a user;
classify a user intent from the user request and a context of the user utterance;
determine to send the user request to one of a first AI model or a second AI model based on a determination that the user intent is fullfillable by one of the first AI model or the second AI model;
generate a first response by one of the first AI model or the second AI model based on the determination; and
transmit the first response to the user.

9. The processing system of claim 8, wherein the computer-executable instructions configured to cause the processing system to determine to send the user request to one of the first AI model or the second AI model further comprises causing the processing system to compare the user intent against a master intent list, the master intent list including a list of intents for which a set of human-curated responses are available through the first AI model.

10. The processing system of claim 9, wherein the user request is generated based on at least the user utterance, customer information, and experience information, where the customer information, and the experience information provide the context of the user utterance.

11. The processing system of claim 10, further comprising computer-executable instructions executable by the processor for causing the processing system to generate the first response using a natural language understanding (NLU) model as the first AI model, causing the processing system to generate the first response includes causing the processing system to:
assign an intent identifier associated with at least one selected response from among the set of human-curated responses, the selected response corresponding to the user intent;
add the user intent to a conversation list; and
add follow-up intents to the conversation list.

12. The processing system of claim 11, wherein the follow-up intents represent probable responses to utterances provided by a user in reaction to the first response.

13. The processing system of claim 11, wherein the computer-executable instructions causing the processing system to generate the first response using the NLU model further comprises causing the processing system to:
apply response rules and response templates, by a dialog manager, to the set of human-curated responses; and
personalize, by the dialog manager, the first response using the customer information.

14. The processing system of claim 10, wherein the first AI model is a natural language understanding (NLU) model using human-curated responses, and the second AI model is a generative AI model referencing a predefined set of information.

15. A composite artificial intelligence system (AI), comprising:
a deterministic AI model configured to generate a first response to a user intent using a set of human-curated responses;
a generative AI model configured to generate the first response to the user intent; and
a dispatcher configured to selectively direct a user utterance to one of the deterministic AI model or the generative AI model based on a determination that the user intent is fulfillable by the deterministic AI model, the dispatcher including:
a classifier configured to identify the user intent based on the user utterance and context extracted from a user request,
a conversation tracker configured to maintain a conversation list, the conversation tracker adding the user intent and follow-up intents to the conversation list, the follow-up intents representing probable responses to subsequent user utterances provided by a user in reaction to the first response, and
a responder configured to receive the first response from the selected one of the deterministic AI model or the generative AI model and present the first response to the user.

16. The composite AI system of claim 15, wherein the dispatcher further comprises a comparator configured to compare the user intent against a master intent list, the master intent list including a list of intents for which a set of human-curated responses are available through the deterministic AI model.

17. The composite AI system of claim 16, wherein a failure of the comparator to match the user intent to an intent in the master intent list causes the dispatcher to direct the user utterance to the generative AI model, the generative AI model being a large language model (LLM).

18. The composite AI system of claim 15, wherein the user request is generated based on at least the user utterance, customer information, and experience information, where the customer information, and the experience information provide the context of the user utterance.

19. The composite AI system of claim 18, wherein the deterministic AI model is a natural language understanding (NLU) model, the NLU further comprising a dialog manager configured to:
apply response rules and response templates to a set of human-curated responses; and
personalize the first response using the customer information.

20. The composite AI system of claim 15, wherein the conversation tracker is further configured to update the conversation list based on subsequent user utterances received in reaction to the first response.
